(19) United States
(12) Patent Application Publication
(10) Pub. No.: US 2026/0187967 A1
(43) Pub. Date: Jul. 2, 2026

(54) METHOD FOR RAPIDLY DETECTING STRAIGHT LINE, PLANE AND HYPERPLANE IN MULTI-DIMENSIONAL SPACE

(71) Applicant: NANJING AGRICULTURAL UNIVERSITY, Nanjing, Jiangsu (CN)

(72) Inventor: Xiangchao GAN, Nanjing (CN)

(73) Assignee: NANJING AGRICULTURAL UNIVERSITY, Nanjing, Jiangsu (CN)

(21) Appl. No.: 18/727,892

(22) PCT Filed: Mar. 14, 2022
(86) PCT No.: PCT/CN2022/080650

§ 371 Date: Jul. 10, 2024

(30) Foreign Application Priority Data
Jan. 12, 2022 (CN) 202210033412.X

(51) Int. Cl. G06V 10/422; G06V 10/28

(52) U.S. Cl. CPC G06V 10/422; G06V 10/28

(57) ABSTRACT

A method for rapidly detecting a straight line, a plane and a hyperplane in a multi-dimensional space. The new method has two important advantages: firstly, the model corresponds to a total least square fitting algorithm and has better tolerance to data noise, so as to solve the problem of the precision of detecting a target on a parameter space segmentation line by means of fast Hough transform being too low; and secondly, in the integrated fast Hough transform, targets that are close to each other in a data space are gathered together in a parameter space, and a calculation process in the parameter space can be displayed by using a visual graph, thereby rapidly determining the number of targets, guiding the setting of system parameters, and distinguishing a target that is repeatedly recognized.

### TECHNICAL FIELD

The present invention pertains to the field of image processing technology and mainly relates to integrated fast Hough transform (IFHT), particularly to a method for rapidly detecting a lines, planes and hyperplanes in a multi-dimensional space, which can be used for data mining, classification and pattern recognition of many kinds of data, such as image data, financial data and array data and can also be applied to image analysis, computer vision, autonomous driving, artificial intelligence, data classification, etc.

### BACKGROUND ART

Straight line detection is the basis of object recognition and plays a fundamental role in image processing and recognition. Since Hough earned a patent in 1962 for his method that allows efficient detection of straight lines in images, which we now call Hough transform (HT), more than 2,500 papers have been devoted to its variant. The 2D HT has also been extended to plane and hyperplane detection in multi-dimensional spaces and applied in many fields, including computer vision, machine learning, artificial intelligence, autonomous driving, data classification, etc.

HF and most variants thereof deal with 2D data and detect straight lines and sometimes specific curves and graphs with appropriate adaptations. HF detects a straight line mainly by two steps: setting a parameter space with a limited length, and designing a mapping function to transform input data to a straight line of the parameter space; dividing the parameter space into a plurality of small accumulators, and using the input data to vote on each accumulator. The accumulator whose votes exceed the specified threshold corresponds to the object detected by HF. The algorithm flow is shown in FIG. 1.

In recent years, with the wide application of laser radar, especially laser radar LiDAR, in autonomous driving and space measurement, HF is more and more widely used in 3D point cloud. When extended to 3D or higher-dimensional data spaces, the simplest detection objects for HF are planes and hyperplanes. However, due to the “curse of data dimensionality”, the computational cost and complexity of the corresponding algorithm in a multidimensional space tend to increase exponentially. At present, only a few HF algorithms can be applied to multidimensional space data. Among them, the fast Hough transform (FHT) (Li, et al., 1986) proposed by Li et al. from IBM in 1986 is recognized to have outstanding performance in computation and storage complexity. The algorithm has wide applications and has been implemented by some open-source computer image processing libraries, such as GANDALF. Interestingly, we noticed literatures sometimes refer FHT to Brady's radon transform-based algorithm (Brady, 1998). To avoid confusion, we hereafter refer FHT to the algorithm developed by Li et al in 1986 unless stated otherwise. Li's FHT is highly efficient in terms of computation and storage complexity in both two-dimensional space and high-dimensional space. This is achieved mainly through a “coarse-to-fine” strategy. For an n-dimensional space, FHT transforms data points to hyperplanes (straight lines in 2D, planes in 3D) in the parameter space and searches for intersection.

In an n-dimensional data space {F₁, F₂, . . . , Fₙ}, the FHT with each data point denoted by F(j)=[F₁(j), F₂(j), . . . , Fₙ(j)] has the following computing flow:
1. Seta k-dimensional parameter space denoted by {X₁, X₂, . . . , Xₖ} and find the corresponding mapping functions that map each data point F (j) into a straight line or a hyperplane in the parameter space which is represented by

$${a}_{o} ( j ) + {\sum }_{i = 1}^{k} {a}_{1} ( j ) {X}_{1} = 0 \qquad ( 1 )$$

where aᵢ(j) is a function of F(j) and satisfies

$${\sum }_{i = 1}^{k} {a}_{i}^{2} ( j ) = 1.$$

2. Set a voting threshold T to determine the minimum data support needed to identify an object and the desired detection resolution q.
3. Divide the parameter space by an iterative algorithm into hypercubes from low to high resolution, represented by and stored with nk-byte trees (k-trees), and perform further division and analysis only on the hypercubes supported with enough votes.

FHT divides the parameter space into n subspaces, which is determined by the mathematical model used. For example, a straight line in a 2D space can be modelled as y=mx+c, with m→∞. A direct search of parameter space [m, c] would be difficult if not impossible because the value of m can be infinite. FHT describes this space with two equations y=mx+c, |m|≤1 and y=mx+c, |m|≤1. This effectively divides the search space into two parameter subspaces (m, c) and (m′, c′), with |m|≤1, |m|<1. The same strategy has been widely used in a plenary of other HT variants such as adaptive Hough transform (Illingworth and Kittler, 1987). Taking 2D FHT for example, a data point (x, y) can lie on any straight line y=mx+c, |m|≤1 or x=m′y+c′, |m′|≤1. The parameter space comprises two sub-spaces (m, c) and (m′, c′). The equations that map the data point (x, y) into a straight line a₀+a₁m+a₂c=0 (|m|≤1) in the first subspace (m, c) are a₀=−y/\sqrt{x²+1}, a₁=x/\sqrt{x²+1} and a₂=1/\sqrt{x²+1}; and the equations that map the data point (x, y) into a straight line a₀+a₁m+a₂c=0(|m|≤1) in the second subspace (m′, c′) are a₀=−x/\sqrt{x²+1}, a₁=y/\sqrt{x²+1} and a₂=1/\sqrt{x²+1}.

FHT divides the parameter space by an iterative algorithm into nested hypercubes from low to high resolution, represented by and stored with n k-trees. Each hypercube in the data space represents a hyperplane with specific precision, called accumulator. For an accumulatorm ∈[m₁, m₂], c∈[c₁, c₂] in the parameter space, testing whether a point (x, y) is located on a line y=mx+c,m∈[m₁, m₂], c∈[c₁, c₂] is equivalent to testing whether it is possible that a₀+a₁m+a₂c=0 where a₀=−y/\sqrt{x²+1}, a₁=x/\sqrt{x²+1}, a₂=1/\sqrt{x²+1}, m∈[m₁,m₂], c=[c₁, c₂]. The latter can be reformulated as testing the intersection of a rectangle m∈[m₁, m₂], c∈[c₁, c₂] and a straight line a₀+a₁m+a₂c=0 intersect, with known values of a₀, a₁, a₂. If [m₁, m₂] and [c₁, c₂] have the same length, which can be achieved through data normalization, the test can be relaxed to check whether the straight line intersects the circumscribing circle, resulting in dramatically reduction in the computational cost (as shown in FIG. 2). For example, in a 2D space, we only need to test whether |a₀+a₁m*+a₂c*|<r, where m* and c* are the coordinates of the square's center and r is the radius of the circumscribing circle of the square.

In the search process, FHT divides the parameter space into n subspaces, and an independent k-tree is responsible for information storage of each subspace. Each subspace can be divided into k hypercubes, corresponding to k nodes of the k-tree, and each hypercube can be iteratively divided into k smaller hypercubes, forming deeper nodes in the k-tree. Deeper division can be performed on a hypercube only when the corresponding hyperplane collects enough votes from data points, and the subdivision stops until the size of the cubes reaches the specified precision. This hierarchical approach leads to a significant reduction on computational cost and storage space.

Searching in multiple independent subspaces separately poses several serious challenges. Though in theory any straight line would not appear in both subspaces, e.g., y=mx+c, |m|≤1 and x=m′y+c′, |m′|<1, in practice straight lines with the slope close to 1 need to be pursuit in both subspaces when noise is considered. Thus, the multiple independent subspaces must overlap marginally with each other to avoid potential gaps. With the increase of the data dimension, significant computational and storage costs are needed for the overlapped regions in the search subspaces.

To make matters worse, the multiple subspaces of FHT use completely different mapping functions. As a consequence, testing whether targets (straight lines in 2D, planes in 3D, hyperplanes in higher dimension) detected in different subspaces are from the same object is a very challenging task. This was indeed noticed in the original FHT publication and is listed as future work. However, to our best knowledge, there is still a lack of reliable method to resolve it.

### SUMMARY OF THE INVENTION

The objective of the present invention is to provide a method for rapidly detecting a straight line, a plane and a hyperplane in a multi-dimensional space to overcome the shortcomings of the prior art.

### The Present Invention Adopts the Following Technical Solution:

In a first aspect, the present invention provides a method for rapidly detecting a straight line, a plane and a hyperplane in a multi-dimensional space. In a data point cloud mode, in an n-dimensional space {F₁, F₂, . . . , Fₙ}, the data point cloud consists of N data points, and each data point is represented by: F(j)=[F₁(j), F₂(j), . . . , Fₙ(j)], j=1 . . . N; the method expresses a straight line, plane or hyperplane in a data space as

$${\sum }_{i = 1}^{n} {β}_{i} {F}_{i} + d \cdot {β}_{n + 1} = 0 ,$$

where

$${\sum }_{i = 1}^{m} {( {τ}_{i} \cdot {β}_{i} )}^{2} = 1 , {β}_{i} ⩾ 0 ,$$

d is a parameter specified by the user, {β₁, β₂, . . . , βₙ₊₁} is a parameter, n corresponds to the dimension of the data, m is n−1 or n, and τᵢ is a data normalization factor, chosen by the user.

Further, in the method, only some specific subsets are detected, including: detection of objects conforming to βₙ₊₁=0, or any object with βᵢ≥0, or objects with βᵢ within a specific value interval.

Further, the method presets system parameters through the following steps:
Step 1: If the m=n model is used, set the value range d of the intercept of the straight line, plane or hyperplane, which is smaller than or equal to the maximum distance dₘₐₓ of each data point in the input point cloud data to the origin of coordinates; if the m=n+1 model is used, d=1 can be set by default.
Step 2: Set a voting threshold T to determine the minimum number of data points needed to identify the object, and set the desired detection resolution q, where the value of q is an integer;
Step 3: Generate a k-tree and set the parameters of the center position of the k-tree root node and the half-length of each dimension;
Step 4: Transform each data point to the parameter space;
Step 5: Calculate the distance from the root node to any data point j,

$${R}_{0} = {\sum }_{i = 1}^{k} {a}_{1} ( j ) {C}_{0 i} / {S}_{0}$$

Test whether Formula |R₀|≤\sqrt{k}/2 is satisfied. If yes, increase the accumulated votes of the root node.
Step 6: If the vote count of the root node is smaller than T, there is no object meeting the requirement in the system, and the system exits. If the vote count is greater than or equal to the threshold T, 2^{k-1} child nodes of the root node that meet the requirement of b₁=1 are generated, and each newly generated node is provided with a vector b=[b₁, . . . , bₖ];
Step 7: Use all N data points to vote on the new node;
Step 8: Detect the vote count of the new node, stop processing the child node if the vote count is smaller than the threshold T, and output the parameter information of the node if the level of the node reaches level q, corresponding to the detection object in the system, and stop the analysis of the node;
Step 9: If the vote count of a new node is greater than or equal to the threshold T, generate 2k sub-nodes at the next level of the node and provide each newly generated node with a vector b=[b₁, . . . , bₖ]; test whether each newly generated node meets Formula

$$\vert {\sum }_{i = 1}^{k - 1} {C}_{i}^{2} - 1 \vert \leq \sqrt{k} {S}_{0} / {2}^{l} ,$$

and abandon the sub-node if not;
Step 10: Iterate through steps 7 to 9 until no new nodes are generated and all nodes have been processed.

Still further, in said step 1, set d to 0 if a straight line, plane, or hyperplane object that passes through the origin of coordinates is detected.

Still further, in said step 3, if all objects in the input data need to be detected, the root node center is located at C₀=(0, . . . , 0), whose half-length in each dimension is S₀=(1, . . . , 1); if only objects in some specific areas of the input data are detected, the root node center is adjusted accordingly

Still further, in said step 4, if all objects in the input data need to be detected, use the following equation:

$${a}_{i} = {F}_{i} ( j ) / \sqrt{{\sum }_{1}^{n} {{F}_{i} ( j )}^{2} + {d}^{2}} , i = 1 , … , n ;$$

$${a}_{n + 1} = d / \sqrt{{\sum }_{1}^{n} {{F}_{i} ( j )}^{2} + {d}^{2}} ;$$

If only objects in some specific areas of the input data are detected, derive with the following formula:

$${a}_{i} ( j ) = \frac{{F}_{i} ( j ) {L}_{i}}{W ( j ) {L}_{n + 1}} , {a}_{n + 1} ( j ) = \frac{1}{W ( j )} ,$$

where W(j) is determined by

$${\sum }_{i = 1}^{n + 1} {a}_{i}^{2} ( j ) = 1.$$

Still further, in said step 7, the voting rule is to calculate the distance of any data point j to the child node:

$${R}_{l + 1} = 2 {R}_{l} + \frac{1}{2} {\sum }_{i = 1}^{k} {a}_{1} ( j ) {b}_{i}$$

And test whether Formula |R|≤\sqrt{k}/2 is satisfied and if yes, increase the accumulated votes of this node, thereby counting the votes of each new node.

Still further, after said step 10, all nodes output in step 8 are counted. If there are more than one output node, the objects that may be duplicate are merged. If no node is output, the system has not detected any objects.

In a second aspect, the present invention provides a computer device, comprising a memory, a processor and computer-readable instructions stored in the memory and running on the processor. The processor implements the rapid detection method described above when executing the computer-readable instructions.

In a third aspect, the present invention provides one or more readable memory media storing computer-readable instructions, which, when executed by one or more processors, cause one or more processors to implement the foregoing rapid detection method.

Advantages of the present invention: The present invention establishes a new mathematical model for a straight line, a plane and a hyperplane, and on the basis of said model, integrated fast Hough transform is developed, such that a single k-byte tree is responsible for information of all search spaces, and by eliminating redundancy, the computational cost and storage requirements in the system are greatly reduced. The new method has two important advantages: firstly, the fitting model of the fast Hough transform corresponds to a least square method, while the integrated fast Hough transform corresponds to a total least square fitting algorithm.

The former assumes that the data noise exists in only one dimension, while the latter model assumes that the data noise is spread across all dimensions, so it has better tolerance to data noise, so as to solve the problem of the precision of detecting a target on a parameter space segmentation line by means of fast Hough transform being too low in practical application. Secondly, in the integrated fast Hough transform, targets that are close to each other in a data space are gathered together in a parameter space, and a calculation process in the parameter space can be displayed by using a visual graph, thereby rapidly determining the number of targets, guiding the setting of system parameters, and distinguishing a target that is repeatedly recognized.

### BRIEF DESCRIPTION OF THE DRAWINGS

FIG. 1 is a standard flow diagram of Hough transform used for straight line or plane detection.

FIG. 2 is a schematic diagram of testing the intersection of a straight line and a square. Whether the straight line intersects a square can be directly tested or whether a straight line intersects the circumscribing circle of a square can be tested, too. The latter will save a lot of time in calculation.

FIG. 3 is a parameter space diagram of multi-scale hierarchical refined IHT; accumulators have the same length along each dimension, and IFHT only needs to analyze the accumulator that intersects the unit circle in the n−1 dimension.

FIG. 4 is a schematic diagram of using a k-tree to represent the entire parameter space. We here use vector b consisting of 0 and 1 to represent different nodes. Each node can be subdivided into 2^{k} child nodes except that there are only 2^{k-1} child nodes for the root node.

FIG. 5 is an intuitive presentation of the segmentation and analysis of IFHT parameter space, where (a) shows 2D input data, with two straight lines; (b) shows IFHT vote distribution of all accumulators at level q=5, and the accumulators with votes exceeding the threshold gather into two independent clusters, corresponding to two straight lines.

FIG. 6 is a schematic diagram of a 3D dataset and a corresponding IFHT parameter space, where (a) shows a 3D dataset and a plane therein, (b) shows analysis results of all accumulators of IFHT at q=5. The accumulators exceeding the threshold gather into an independent cluster, corresponding to the plane in the dataset.

FIG. 7 is a schematic diagram of different object functions used in FHT and IFHT straight line detection, where (a) shows the total square value of the deviation minimized by FHT along the y axis, corresponding to fitting by the least square method, (b) shows the sum of the square values of all Euclidean distances minimized by IFHT, corresponding to fitting by the total least square method.

FIG. 8 is a schematic diagram of performance comparison of FHT and IFHT in straight line detection. Two levels of noise are added to the second dimension of data, respectively, where (a) shows general straight line detection, (b) shows that when a straight line corresponds to the boundary value of an accumulator on the parameter plane of IFHT and FHT, FHT performance drops dramatically, while IFHT performance is basically unchanged.

FIG. 9 is a schematic diagram of algorithm performance comparison of IFHT and FHT when noise is evenly distributed in all dimensions of data. The standard deviation of simulated noise is 0.02 and 0.067, respectively.

FIG. 10 is a schematic diagram of a computer system that can be used to host the present invention.

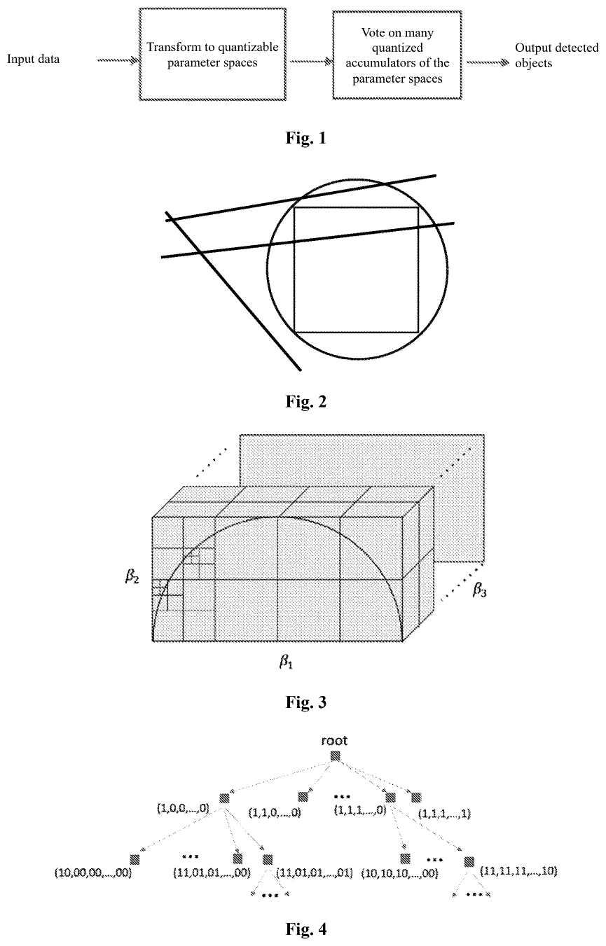

### DETAILED DESCRIPTION

Below the present invention is described in detail in conjunction with the accompanying drawings and embodiments.

### 1. Mathematical Model for IFHT

IFHT uses a more intuitive mathematical model to represent a straight line as well as a plane and a hyperplane in a multidimensional space. Let the input be a data point F(j)=[F₁(j), F₂(j), . . . , Fₙ(j)] in an n-dimensional space {F₁, F₂, . . . , Fₙ}. IFHT uses the following mathematical model to represent a hyperplane:

$${\sum }_{i = 1}^{n} {β}_{i} {F}_{i} + {β}_{n + 1} = 0 , where \qquad ( 2 )$$

$${\sum }_{i = 1}^{n} {( {τ}_{i} \cdot {β}_{i} )}^{2} = 1 and {β}_{i} \geq 0$$

Here τᵢ is a data normalization factor, and the way to select it will be discussed later. For simplicity, we here relax the constraint of the model by dropping the requirement β₁≥0. Suppose we know the value ranges of {β₁, β₂, . . . , βₙ₊₁}. Assume the half-length of the value ranges are {L₁, L₂, . . . , Lₙ₊₁}. We have:

$${\sum }_{i = 1}^{n} \frac{{F}_{i} ( j ) {L}_{i}}{W ( j ) {L}_{n + 1}} \frac{{β}_{i}}{{L}_{i}} + \frac{{β}_{n + 1}}{W ( j ) {L}_{n + 1}} = 0 forall j ∈ Ω$$

Let

$${X}_{i} = \frac{{β}_{i}}{{L}_{i}}$$

The foregoing formula is transformed to

$${\sum }_{i = 1}^{n + 1} {a}_{i} ( j ) {X}_{1} = 0 , {a}_{i} ( j ) = \frac{{F}_{i} ( j ) {L}_{i}}{W ( j ) {L}_{n + 1}} , {a}_{n + 1} ( j ) = \frac{1}{W ( j )} ,$$

where W(j) is a weight variable to ensure

$${\sum }_{i = 1}^{n + 1} {a}_{i}^{2} ( j ) = 1.$$

To summarize the above derivation, the transformation for a detection object

$${\sum }_{i = 1}^{n} {β}_{i} {F}_{i} + {β}_{n + 1} = 0 , {\sum }_{i = 1}^{m} {( {τ}_{i} \cdot {β}_{i} )}^{2} = 1$$

and βᵢ≥0 in data space {F₁, F₂, . . . , Fₙ} to parameter space {X₁, X₂, . . . , Xₖ} is

$${\sum }_{i = 1}^{n + 1} {a}_{i} ( j ) {X}_{i} = 0 \qquad ( 3 )$$

where the mapping function from F(j)=[F₁(j), F₂(j), . . . , Fₙ(j)] to parameter space {X₁, X₂, . . . , Xₖ} is

$${a}_{i} ( j ) = \frac{{F}_{i} ( j ) {L}_{i}}{W ( j ) {L}_{n + 1}} , {a}_{n + 1} ( j ) = \frac{1}{W ( j )} ,$$

where the value of W(j) is determined by

$${\sum }_{i = 1}^{n + 1} {a}_{i}^{2} ( j ) = 1.$$

In the parameter space {X₁, X₂, . . . , Xₖ}, each dimension Xᵢ is in [−1, 1] and the parameter space can be subdivided into small hypercubes (accumulators) for voting. In addition, the requirement of β₁≥0 can be easily satisfied by dropping the accumulators that do not meet the requirement.

For example, in a 2D space, any straight line passing through a point (x, y) can be represented by β′₁x+β′₂y+β′₃=0, β′₁²+β′₂²=1, β′₁≥0, |β′₃|≤d, where d is a specified parameter that is smaller than or equal to the maximum distance dₘₐₓ of all data points to the origin. Suppose β′₃=d·β₃, β′₁=β₁, β′₂=β₂ and temporarily not consider the constraint of β′₁≥0, we can transform the above formula into β₁x+β₂y+d·β₃=0, B₁²+β₂²=1, |βᵢ|≤1, i=1, 2, 3. (β₁, β₂, β₃) constitutes our parameter space. The mapping function for transforming the data point (x, y) to parameter space α₁β₁+α₂β₂+α₃β₃=0, β₁²+β₂²=1, |β₃|≤1 is α₁=x/\sqrt{x²+y²+d²}, a₂=y/\sqrt{x²+y²+d²} and α₃=d/\sqrt{x²+y²+d²}. Because |βᵢ|≤1 for i=1, 2, 3, the parameter space (β₁, β₂, β₃) has the same length of 2 in all dimensions and can be subdivided into cubes of equal length as accumulators.

In the above explanation, the dimension of the parameter space is n+1 for the n-dimensional input data. This is not necessarily so. For example, if we are interested in target objects (lines, planes or hyperplanes) with zero intercept, i.e., objects that pass through the origin, the IFHT parameter space will be n-dimensional. We hereafter denote k as the dimension of the IFHT parameter space for generality.

### 2. Multi-Scale Hierarchical Refined Computing Model

Every data point in the data space corresponds to a straight line or plane in the IFHT parameter space. In reality, the measurement error and noise correspondence in the data will cause the offset of the corresponding object in the parameter space. In the IFHT parameter space, noise tolerance and detection resolution can be achieved by detecting a small interval rather than just a specific value. The length of the detected small interval corresponds to the resolution of our final detection object. For the data point cloud in a data space, when the straight line, plane, hyperplane and other objects supported by more than T data points are detected, IFHT will first divide the parameter space into many small accumulators and let each data point vote on them. Since the IFHT parameter space has the same length in each dimension, the divided small accumulators are equal in each dimension and in the parameter space, the accumulators are made up of squares, cubes, or hypercubes (depending on data dimension).

IFHT parameter space is linear. If a large cube collects T votes from data points and the small cubes subdivided from the cube are voted on, it is impossible for any small cube to collect more votes than the original cube, and a data point that supports any small cube must be a subset of a data point that supports the large cube. This allows the IFHT parameter space to be quantized hierarchically in a multi-scale refined manner. We can divide IFHT parameter space into several large accumulators for voting and then divide only those with enough votes into smaller accumulators for further testing until the required resolution is achieved. This coarse-to-fine strategy pose great advantage compared to other polar-coordinate based Hough transform methods.

Since accumulators in the IFHT parameter space have the same length in all dimensions, we can use the approximation algorithm shown in FIG. 2 to accelerate. The formula for determining whether a data point votes for an accumulator can be written as

$$\vert {\sum }_{i = 1}^{k} {a}_{i} ( j ) {C}_{i} \vert \leq r \qquad ( 4 )$$

[C₁, C₂, . . . , Cₖ] is the center position of the accumulator, and r is the radius of the accumulator's circumscribing circle.
   3. Use a k-Tree to Realize Storage and Computation

In IFHT, the parameter space is a hollow hyper-cylinder (FIG. 3). We use a multi-scale nested hypercube to traverse the entire parameter space, corresponding to a k-tree data structure to store information and perform computation. The root node of the k-tree corresponds to a hypercube centered at a vector C₀ with half-side-length S₀. Each node of the tree has 2k child nodes. A vector b=[b₁, . . . , bₖ] where each bⱼ is −1 or 1 is used as an index for a child node. If a node at level/has center C₁, then the center of its child node with index [b₁, . . . , bₖ] is

$${C}_{l} + \frac{{S}_{l + 1}}{2} \cdot b$$

where Sₗ₊₁ is the half-length of all nodes at level l+1 and Sₗ₊₁=Sₗ/2.

IFHT borrows the multi-scale hierarchical refinement and iterative calculation method from FHT algorithm. For an accumulator at level l centered at [C₁₁, C₁₂, . . . , Cₗₖ], the distance Dₗ to a hyperplane defined in Formula 3 is equal to

$${D}_{l} = {\sum }_{i = 1}^{k} {a}_{i} ( j ) {C}_{li} .$$

By normalizing the distance with half-side-length, we have:

$${R}_{l} = {\sum }_{i = 1}^{k} {a}_{i} ( j ) {C}_{li} / {S}_{l} \qquad ( 5 )$$

We can iteratively calculate the normalized distance of any accumulator. Suppose the initial values of parameter space {X₁, X₂, . . . , Xₖ} are centered at C₀=[C₀₁, C₀₂, . . . , C₀ₖ], we have:

$${R}_{0} = {\sum }_{i = 1}^{k} {a}_{i} ( j ) {C}_{0 i} / {S}_{0} \qquad ( 6 )$$

$${R}_{l + 1} = 2 {R}_{l} + \frac{1}{2} {\sum }_{i = 1}^{k} {a}_{i} ( j ) {b}_{i}$$

The formula of whether any data point in Formula 4 votes for an accumulator can be simplified as:

$$\vert R \vert \leq \sqrt{k} / 2 \qquad ( 7 )$$

In Formula 2, we use constraint

$${\sum }_{i = 1}^{k - 1} {( {τ}_{i} \cdot {β}_{i} )}^{2} = 1$$

to guarantee that the straight line or plane is unique. If we do not have any additional information about the object we need to detect, and the initial ranges of {β₁, . . . , βₙ) is |βᵢ|≤1, then the foregoing constraint of

$${\sum }_{i = 1}^{k - 1} {( {τ}_{i} \cdot {β}_{i} )}^{2} = 1$$

can be simplified into:

$${\sum }_{i = 1}^{k - 1} {β}_{i}^{2} = 1 \qquad ( 8 )$$

In the parameter space, this is equivalent to test whether a hypercube intersect a unit circle/sphere in (k−1) dimension. Following the same principle of the simplification used for Formula 4, for an accumulator centered at [C₁, C₂, . . . , Cₖ] at level l, with r being the radius of the circle circumscribing the accumulator, the test formula can be simplified into

$$\vert {\sum }_{i = 1}^{k - 1} {C}_{i}^{2} / {S}_{0} - 1 \vert \leq \sqrt{k} / {2}^{l} \qquad ( 9 )$$

### 4. IFHT Algorithm Flow

In n-dimensional space {F₁, F₂, . . . , Fₙ}, a set of data point cloud F(j)=[F₁(j), F₂(j), . . . , Fₙ(j)] is given. IFHT uses a transformation that maps each F (j) into the parameter space {X₁, X₂, . . . , Xₖ} which results in that any hyperplane is represented by

$${\sum }_{i = 1}^{k} {a}_{i} ( j ) {X}_{i} = 0 ,$$

which aᵢ(j) is a function of F(j), and is normalized such that

$${\sum }_{i = 1}^{k} {a}_{i}^{2} ( j ) = 1$$

For a typical case where no preference or prior information exists, the target hyperplanes can be modelled as

$${\sum }_{i = 1}^{n} {( {τ}_{i} \cdot {β}_{i} )}^{2} = 1 , {β}_{i} ⩾ 0 ,$$

where

$$k = n + 1 , {a}_{i} ( j ) = \frac{{F}_{i} ( j )}{W ( j ) d} , j = 1 , … , n , and {a}_{n + 1} ( j ) = \frac{1}{W ( j )}$$

d is a parameter specified by the user, which is smaller than or equal to the maximum distance dₘₐₓ of all data points to the origin. The mapping function is

$${\sum }_{i = 1}^{n + 1} {a}_{i}^{2} ( j ) = 1.$$

where W(j) is a weighted scale used to insure

$${\sum }_{i = 1}^{n} {β}_{i} {F}_{i} + d \cdot {β}_{n + 1} = 0 ,$$

Seta voting threshold T to determine the minimum data support needed to identify an object and the desired detection resolution q.

### The IFHT Calculation Process is as Follows:

Set a k-tree root node, which is located at (0, . . . , 0) and whose half-length in each dimension is (1, . . . , 1), calculate the distance of the root node to all data points and calculate the votes. If the vote count is greater than the threshold T, generate 2^{k-1} child nodes of the root node that meet the requirement of b₁=1.

Determine whether each child node satisfies Formula 9. If not, abandon the child node. If yes, calculate the normalized distance of each data point by Formula 6, and complete the voting on each child node by testing whether Formula 7 is satisfied. If the vote count is smaller than the threshold T, abandon the child node, and if not, refine the child node again to generate 2^{k} child nodes.

Iterate the child nodes generated in the above steps. Finally, record all nodes that reach the specified resolution q and collect votes greater than the threshold T. If no node can reach the specified resolution q and the number of votes collected is greater than the threshold T, the node with the highest resolution can be reported (if there are multiple nodes, the node with the highest votes is recorded).

### 5. Other Possible Variants of IFHT

In the IFHT described above, a straight line, plane or hyperplane is modelled as

$${\sum }_{i = 1}^{n} {β}_{i} {F}_{i} + {β}_{n + 1} = 0$$

$$where$$

$${\sum }_{i = 1}^{n} {( {τ}_{i} \cdot {β}_{i} )}^{2} = 1 , and {β}_{1} ⩾ 0$$

It is possible to modify the above formula slightly in certain scenarios. One modification could be to put βₙ₊₁ into the normalization equation. This would relieve us from calculating the maximum distance of all data points to the origin in the beginning. The corresponding equation is as follows:

$${\sum }_{i = 1}^{n} {β}_{i} {F}_{i} + {β}_{n + 1} = 0$$

$$where$$

$${\sum }_{i = 1}^{n + 1} {( {τ}_{i} \cdot {β}_{i} )}^{2} = 1 , {and β}_{1} ⩾ 0$$

In addition, the implementation of IFHT algorithm could be modified slightly. In the IFHT mathematic model, n+1 variables (β₁, . . . , βₙ₊₁) have been used. However, when {β₁, . . . , βₙ₊₁} is determined, β₁ can be uniquely decided and serves as a dummy variable. It is possible to calculate β₁ straightforwardly without putting it into the parameter space in the IFHT implementation.

### 6. IFHT Results

In almost all variants of Hough transform, the quantization resolution q of parameter space is an important parameter. If a small value of q is chosen, too many objects could be reported which cannot satisfy the required resolution; when a large value of q is chosen, the algorithm could be too sensitive to noise, resulting in the omission of particular objects. In the practical application of FHT, we can often see that when the precision of the same target is q, multiple accumulators report finding the detection object at the same time and they correspond to the same object, but no object can be found at level q+1. Therefore, automatically identifying the same object in HT or FHT relies on a lot of post-processing.

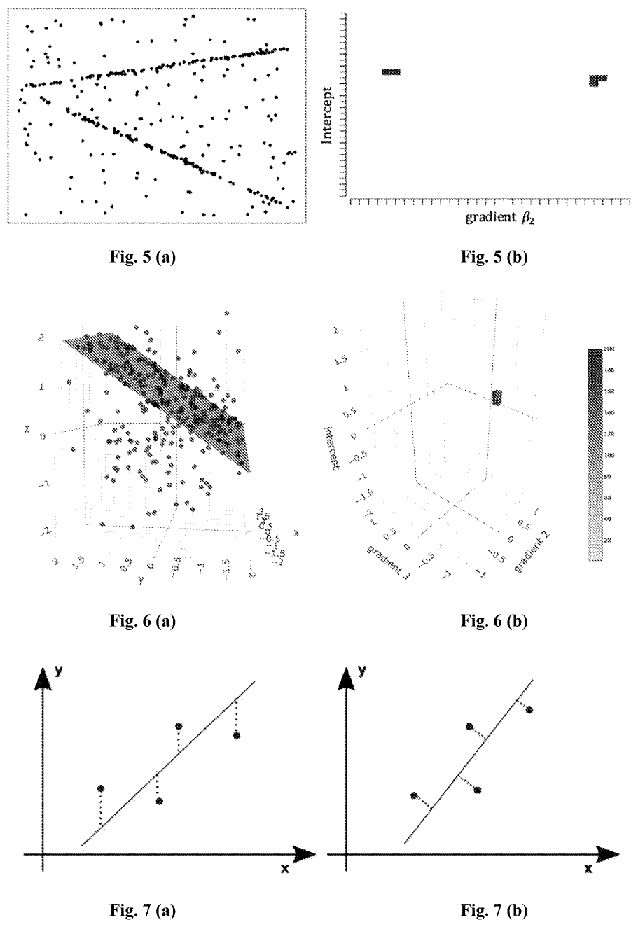

In IFHT, the integrated parameter space allows an intuitive presentation of segmentation and computation progress in parameter space, which provides an intuitive insight on determining system parameters and making intuitive judgments about possible duplicate objects in the outcome. In FIG. 5 and FIG. 6, data analysis results of the parameter space of a 2D dataset and a 3D data set in IFHT operation are shown respectively. We can see that when the quantization resolution q is relatively low, multiple accumulators will find the same object, but the accumulators that detect the same object always cluster together in the parameter space, so users can intuitively determine how many objects to be detected are contained in their data, and at the same time determine system parameters and merge repeatedly detected objects.

The IFHT algorithm has some interesting properties. In the FHT model, noise is not assumed to be evenly distributed across all dimensions. For example, in 2D data, y=mx+c, |m|=1 and x=m′y+c′, |m′|<1 are used together for describing all straight lines. When we use the first formula to fit the input data point cloud, the least square method minimizes the total square value of the deviation along the y axis, as shown in FIG. 7a. IFHT fits all dimension at the same time and essentially changes the least square fitting to the total least square fitting. In a 2D space, we look for a (β₁, β₂) value that satisfies β₁x+β₂y+β₃=0 and β₁²+β₂²=1 by minimizing the sum of the squared values of all Euclidean distances. The fitting can be illustrated in FIG. 7b.

We compared the performance of IFHT and HFT with synthesized data using Monte Carlo method. In the first experiment, a specific number N of data points from a straight line y=0.8x+0.24+gin 2D space were generated, where x satisfies the uniform distribution of (−2, 2) and g is gaussian white noise with standard deviation 0.02 and 0.067, corresponding to the signal-to-noise ratio of 0.03% and 0.1%, respectively. N data points with x, y˜N (0, 1) are added to the dataset as background noise. For each set of parameters, 100 images were generated. IHFT and HFT with the same parameters (T=N/2 and q=5) were used to detect the line in each image. FIG. 7a shows that in both scenarios, IFHT has a higher detection rate than FHT.

After the initial values of parameters are set, the size and boundary of the accumulators will be determined. The algorithm analysis indicates that when a straight line corresponds to the boundary value of the accumulator, the detection resolution of FHT will be greatly reduced (Illingworth and Kittler, 1987). Due to the different models have been used, only very few straight lines cause this type of problem to both FHT and IFHT methods. Straightliney=0.5 is one of them when parameters (q=5 and d=2) are used in both methods. FIG. 7b shows the performance of FHT and IFHT when the standard deviation of the noise is 0.02 and 0.067, respectively. The performance of IFHT was not significantly affected, while the performance of FHT was indeed seriously undermined in this scenario.

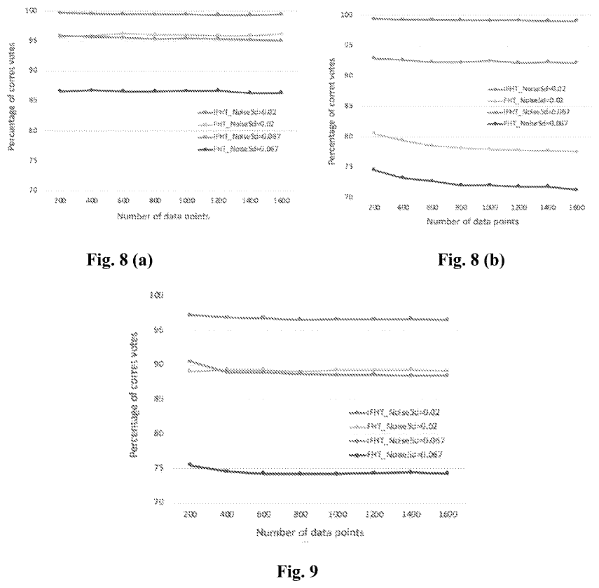

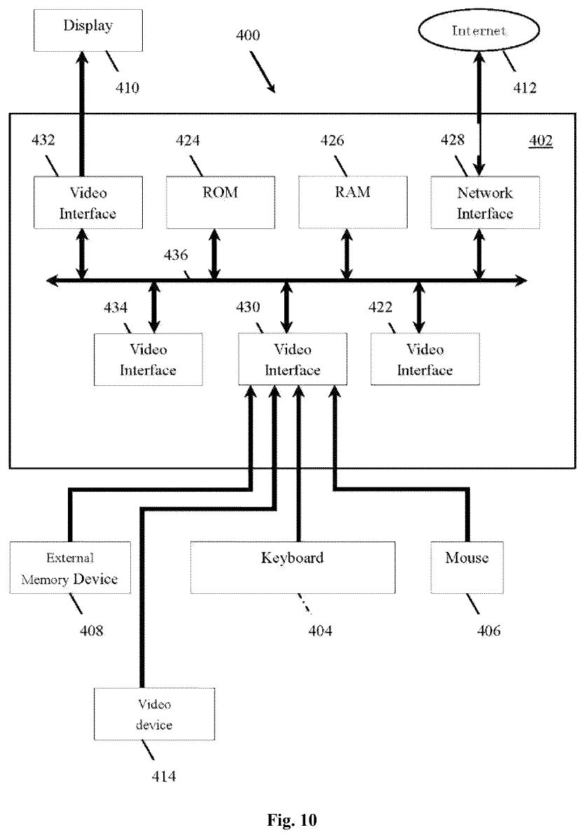

In above simulations, the noise has only been added into the second dimension of the data. This would be rare in the real data. We repeated the first experiment with noise presented across both dimensions. The model we used is y=0.8t+0.24+g2, x=t+g1, t˜U(−2, 2). Here g1 and g2 are gaussian white noise with the same standard deviation. IFHT and FHT parameters (q=5 and d=2) are used for object detection, and the results are shown in FIG. 8. Apparently, at different noise levels, IFHT has significantly better performance than FHT.

The present invention can be implemented using software, or through special hardware, or through a combination of software and hardware. The hardware can even be a general-purpose computer system. The present invention can be integrated as a module. The module and its functions can be implemented through software or hardware. In software implementation, this module can be a process, a computer program, or part of them to implement a specific function or related function. In hardware implementation, this module can be a functional hardware unit that works with other components. For example, the module can be a digital electronic component or part of a digital circuit such as an application specific integrated circuit (ASIC).

FIG. 10 shows a schematic diagram of a computer system 400 that can be used to implement the above invention. The computer 402 is equipped with software that implements the above invention as well as a memory needed for software execution. The software is executed on the operating system of the computer system and is responsible for implementing and executing the technology described in the present invention and obtaining the program results by the computer system 400.

Computer software is a set of logical instructions that a processor (such as a computer CPU) can translate. It can be made up of any language or expression and contains a series of instructions that allow the processor to complete a specific function. This process may also need to be translated into other languages, codes, or marks.

Computer software typically uses a specific computer language to write the source program and through the language compiler to convert the source program into machine language codes that can be executed by the operating system or machine. The writing of computer software may involve other program components, class libraries, etc., which are used to provide support for the present invention to complete the specified function.

The computer system 400 comprises: a computer 402, input devices such as a keyboard 404, a mouse 406 or an external memory 408 (such as CD, DVD and USB flash drive), an output device 410, network connection devices (a WAN connection device 412 and an LAN connection device), or other data devices (such as video device, image acquisition device, laser radar, data acquisition device and data preprocessing device). The computer 402 comprises: a processor 422, an ROM 424, an RAM 426, a network interface 428 for connecting external network connection devices, I/O interfaces 430 for connecting input devices, output devices and other data devices and data storage devices. Each part of the computer 402 is connected through the system bus 436, so that the information and data exchange of each part is maintained. The computer system 400 described here is schematic, and other configurations can also complete the functions of the patent.

The above shows and describes the basic principle, main features and advantages of the present invention. Those of ordinary skill in the art should understand that the above embodiments do not in any way limit the scope of protection of the present invention, and that any technical solution obtained by means of equivalent substitution falls within the scope of protection of the present invention. The parts not covered by the present invention are identical to the prior art or can be implemented using the prior art.

1. A method for rapidly detecting a straight line, a plane and a hyperplane in a multi-dimensional space, wherein in a data point cloud mode, in an n-dimensional space {F₁, F₂, . . . , Fₙ}, the data point cloud consists of N data points, and each data point is represented by: F(j)=[F₁(j), F₂(j), . . . , Fₙ(j)], j=1 . . . N; the method expresses a straight line, plane or hyperplane in a data space as
$${\sum }_{i = 1}^{n} {β}_{i} {F}_{i} + d \cdot {β}_{n + 1} = 0 ,$$
where
$${\sum }_{i = 1}^{m} {( {τ}_{i} \cdot {β}_{i} )}^{2} = 1 , {β}_{i} \geq 0 ,$$
d is a parameter specified by the user, {β₁, β₂, . . . , βₙ₊₁} is a parameter, n corresponds to the dimension of the data, m is n−1 or n, and τᵢ is a data normalization factor, chosen by the user.

2. The method for rapidly detecting a straight line, a plane and a hyperplane in a multi-dimensional space according to claim 1, wherein in the method, only some specific subsets are detected, including: detection of objects conforming to βₙ₊₁=0, or any object with βᵢ≥0, or objects with βᵢ within a specific value interval.

3. The method for rapidly detecting a straight line, a plane and a hyperplane in a multi-dimensional space according to claim 1, wherein the method presets system parameters through the following steps:
step 1: if the m=n model is used, set the value range d of the intercept of the straight line, plane or hyperplane, which is smaller than or equal to the maximum distance dₘₐₓ of each data point in the input point cloud data to the origin of coordinates; if the m=n+1 model is used, d=1 can be set by default.
step 2: set a voting threshold T to determine the minimum number of data points needed to identify the object, and set the desired detection resolution q, where the value of q is an integer;
step 3: generate a k-tree and set the parameters of the center position of the k-tree root node and the half-length of each dimension;
step 4: transform each data point to the parameter space;
step 5: calculate the distance from the root node to any data point j,
$${R}_{0} = {\sum }_{i = 1}^{k} {a}_{i} ( j ) {C}_{0 i} / {S}_{0}$$
test whether Formula |R|≤\sqrt{k}/2 is satisfied. If yes, increase the accumulated votes of the root node;
step 6: if the vote count of the root node is smaller than T, there is no object meeting the requirement in the system, and the system exits; if the vote count is greater than or equal to the threshold T, 2^{k-1} child nodes of the root node that meet the requirement of b₁=1 are generated, and each newly generated node is provided with a vector b=[b₁, . . . , bₖ];
step 7: use all N data points to vote on the new node;
step 8: detect the vote count of the new node, stop processing the child node if the vote count is smaller than the threshold T, and output the parameter information of the node if the level of the node reaches level q, corresponding to the detection object in the system, and stop the analysis of the node;
step 9: if the vote count of a new node is greater than or equal to the threshold T, generate 2^{k} sub-nodes at the next level of the node and provide each newly generated node with a vector b=[b₁, . . . , bₖ]; test whether each newly generated node meets Formula
$$\vert {\sum }_{i = 1}^{k - 1} {C}_{i}^{2} / {S}_{0} - 1 \vert \leq \sqrt{k} / {2}^{l} ,$$
and abandon the sub-node if not;
step 10: iterate through steps 7 to 9 until no new nodes are generated and all nodes have been processed.

4. The method for rapidly detecting a straight line, a plane and a hyperplane in a multi-dimensional space according to claim 3, wherein in said step 1, set d to 0 if a straight line, plane, or hyperplane object that passes through the origin of coordinates is detected.

5. The method for rapidly detecting a straight line, a plane and a hyperplane in a multi-dimensional space according to claim 3, wherein in said step 3, if all objects in the input data need to be detected, the root node center is located at C₀=(0, . . . , 0), whose half-length in each dimension is S₀=(1, . . . , 1); if only objects in some specific areas of the input data are detected, the root node center is adjusted accordingly.

6. The method for rapidly detecting a straight line, a plane and a hyperplane in a multi-dimensional space according to claim 3, wherein in said step 4, if all objects in the input data need to be detected, use the following equation:
$${a}_{i} = {F}_{i} ( j ) / \sqrt{{\sum }_{1}^{n} {{F}_{i} ( j )}^{2} + {d}^{2}} , i = 1 , … , n ;$$
$${a}_{n + 1} = d / \sqrt{{\sum }_{1}^{n} {{F}_{i} ( j )}^{2} + {d}^{2}} ;$$
if only objects in some specific areas of the input data are detected, derive with the following formula:
$${a}_{i} ( j ) = \frac{{F}_{i} ( j ) {L}_{i}}{W ( j ) {L}_{n + 1}} , {a}_{n + 1} ( j ) = \frac{1}{W ( j )} ,$$
where W(j) is determined by
$${\sum }_{i = 1}^{n + 1} {a}_{i}^{2} ( j ) = 1.$$

7. The method for rapidly detecting a straight line, a plane and a hyperplane in a multi-dimensional space according to claim 3, wherein in said step 7, the voting rule is to calculate the distance of any data point j to the child node:
$${R}_{l + 1} = 2 {R}_{l} + \frac{1}{2} {\sum }_{i = 1}^{k} {a}_{i} ( j ) {b}_{i}$$
and test whether Formula |R|≤\sqrt{k}/2 is satisfied and if yes, increase the accumulated votes of this node, thereby counting the votes of each new node.

8. The method for rapidly detecting a straight line, a plane and a hyperplane in a multi-dimensional space according to claim 3, wherein after said step 10, all nodes output in step 8 are counted; if there are more than one output node, the objects that may be duplicate are merged; and if no node is output, the system has not detected any objects.

9. A computer device, comprising a memory, a processor and computer-readable instructions stored in the memory and running on the processor, wherein the processor implements the rapid detection method described in claim 1 when executing the computer-readable instructions.

10. One or more readable memory media storing computer-readable instructions, which, when executed by one or more processors, cause one or more processors to implement the foregoing rapid detection method described in claim 1.
